(19) United States
(12) Patent Application Publication
(10) Pub. No.: US 2010/0031926 A1
(43) Pub. Date: Feb. 11, 2010

(54) INTAKE MANIFOLDS FOR INTERNAL COMBUSTION ENGINES

(76) Inventor: Jerry Lee Magnuson, Oxnard, CA (US)

Correspondence Address: FOX ROTHSCHILD LLP, 2000 MARKET STREET, 10th Floor, PHILADELPHIA, PA, 19103, US

(21) Appl. No.: 12/537,691

(22) Filed: Aug. 7, 2009

Related U.S. Application Data
(60) Provisional application No. 61/087,478, filed on Aug. 8, 2008.

(51) Int. Cl. F02M 55/02; F02M 35/10; F02D 41/30

(52) U.S. Cl. 123/468; 123/184.53; 701/104

(57) ABSTRACT

Embodiments of inlet manifolds for use in air-induction systems for internal combustion engines can have ports with a reduced flow area that causes the airstream within the ports to move at a relatively high velocity. Also, the ports can be shaped to focus the airstream at the fuel injectors mounted on the manifolds.

### CROSS-REFERENCE TO RELATED APPLICATIONS

This application claims the benefit under 35 U.S.C. §119(e) of U.S. provisional application No. 61/087,478, filed Aug. 8, 2008, the contents of which are incorporated by reference herein in their entirety.

### TECHNICAL FIELD

The embodiments disclosed herein relate to internal combustion engines, and in particular to intake manifolds used as part of air-induction systems for such engines.

### BACKGROUND

Internal combustion engines operate by combusting a mixture of air and fuel in a cylinder to produce a high-temperature, high-pressure gas. The energy released by the combustion process is extracted from the gas by a piston disposed for reciprocating movement within the cylinder.

The combustion air is typically supplied to the cylinder via ports formed in an intake manifold and a cylinder head. Fuel injectors are commonly mounted on the manifold, and inject fuel into the air as it passes through the manifold ports. The fuel atomizes into the airstream, and the resulting mixture of fuel droplets and air flows into the cylinder via the cylinder head. The mixture is combusted in a combustion chamber formed by the cylinder and the cylinder head.

The effective port opening, or flow area of the intake-manifold ports is usually sized to accommodate a maximum airflow that occurs when the engine is operating at its maximum power. The engine airflow is lower than its maximum, however, when the engine is operating at idle, cruise, and other part-power conditions. The ports in the intake manifold and cylinder head, therefore, are usually oversized for the airflow that occurs when the engine is operating at part-power. Oversized ports, in turn, cause the velocity of the air flowing through the ports to be relatively low during part-power operation.

Injecting fuel into a relatively slow-moving airstream can result in less than optimal atomization of the fuel. In particular, the relatively low shear forces that occur between the jet of fuel produced by the fuel injector and the relatively slow airstream cause the size of fuel droplets to be relatively large, which in turn decreases the efficiency at which the combustion of the air-fuel mixture occurs. Moreover, the relatively low velocity of the airstream at part-power can cause the distribution of the fuel droplets in the airstream to be less uniform than in a higher-velocity high airstream, which further decreases combustion efficiency. Low combustion efficiency can have a detrimental effect on the power, emission levels, and fuel consumption of the engine.

Injecting the fuel into a relatively low-velocity airstream can also increase the dwell time of the air-fuel mixture in the intake port of the cylinder head. Increases in dwell time, in turn, can cause the fuel droplets to settle out, i.e., come out of suspension in the airstream, and collect on the walls of the intake port due to the relatively low temperatures within the inlet port. For example, the heat of vaporization of gasoline is about 160° F., and the temperature of the walls of a typical inlet port can be well below this value. Thus, the fuel droplets proximate the wall may tend to come out of suspension if the dwell time of the air-fuel mixture in the port is not minimized. The loss of fuel droplets available for combustion can result in a less than optimum air-fuel ratio in the cylinder, which in turn can adversely affect engine power, engine emissions and fuel consumption.

Moreover, a low-quality air-fuel mixture, i.e., a mixture with relatively large fuel droplets distributed in a relatively non-uniform manner, can increase the tendency for the mixture to detonate, or auto-ignite, in the combustion chamber, which in turn can result in engine overheating and other potentially damaging effects. To avoid detonation, most contemporary automobile engines automatically enrich, i.e., lower, the air-fuel ratio during acceleration and high-power operation, where detonation is most likely to occur. Enriching the mixture, however, usually increases engine fuel consumption and emissions.

For example, most contemporary engines operate with a fuel-air ratio of about 14.7:1 at part power, steady-state conditions. The particular ratio results in stoichiometric combustion in which all of the constituent elements of the mixture, including the fuel, are completely burned. During acceleration and high-power operating conditions, e.g., about 90 percent throttle and above, the engine control system enriches the mixture by lowering the air-fuel ratio to, for example, 12.5:1, to avoid detonation.

The need to enrich the air-fuel mixture can be particularly troublesome in forced-induction engines, e.g., engines equipped with a supercharger that pressurizes the intake air before it enters the intake manifold. For example, Applicant has found that installing a modified Roots blower on an otherwise stock eight-cylinder, 6.0-liter General Motors V-type engine, and operating the blower at six pounds per square inch (psi) of boost will cause the engine to operate with unsatisfactory emission levels throughout the drive profile used to evaluate emissions under the California state motor vehicle pollution control standards. It is believed that this effect is due to the enrichment of the air-fuel mixture that occurs at relatively low power in response to the boost of the supercharger. More particularly, the supercharger, which is a positive-displacement compressor, begins to produce boost at relatively low engine power settings. This boost causes the engine to begin enriching the air-fuel mixture at lower power settings than it would in a normally-aspirated, i.e., non-supercharged, engine, thereby increasing emissions (and fuel consumption) at these power settings.

### SUMMARY

Embodiments of inlet manifolds for use in air-induction systems for internal combustion engines can have ports with a reduced flow area that causes the airstream within the ports to move at a relatively high velocity. Also, the ports can be shaped to focus the airstream at the fuel injectors mounted on the manifolds.

Embodiments of systems for supplying a mixture of fuel and air to a cylinder of an internal combustion engine comprise a cylinder head having an inlet port for directing the mixture of air and fuel to the cylinder; a fuel injector; and a manifold having a port in fluid communication with the inlet port of the cylinder head. An inlet of the manifold port receives an airstream. The fuel injector is mounted on the manifold and injects fuel into the airstream to form the mixture of air and fuel. An exit of the manifold port has a flow area between about 20 percent and about 60 percent of a flow area of an entrance of the inlet port.

Embodiments of air-induction systems are provided for internal combustion engines comprising a cylinder and a piston disposed for reciprocating movement within the cylinder. The air-induction systems comprise a compressor and a manifold in fluid communication with the compressor. The manifold has a port that receives pressurized air from the compressor and a bore that receives a fuel injector for discharging fuel into the pressurized air received by the manifold port from the compressor to form a mixture of air and fuel. A minimum flow area of the port is undersized in relation to a maximum flow-rate at which the air and fuel mixture can be drawn into the cylinder at maximum engine power by the reciprocating movement of the piston.

Embodiments of electronic fuel injection systems for internal combustion engines comprise a fuel injector that discharges fuel, and an electronic control unit communicatively coupled to the fuel injector. The fuel injector is responsive to an input from the electronic control unit that regulates an amount of the fuel discharged by the fuel injector. The embodiments also comprise a manifold. The manifold comprises a body having a wall surface defining a port that receives an airstream. The fuel injector is mounted on the manifold so that a portion of the fuel injector is located in the port, and the wall surface is shaped to focus the airstream at the portion of the fuel injector located in the port.

Methods for providing a mixture of fuel and air to a combustion chamber of an internal combustion engine comprise compressing the air in a compressor such as a supercharger; accelerating the pressurized air in a port of an intake manifold; injecting fuel into the pressurized air at a location within the port at which the velocity of the air is at or near its maximum; and directing the resulting mixture of air and fuel into an inlet port of a cylinder head. The inlet port of the cylinder head can have a flow area greater than a flow area of an exit of the port of the intake manifold. The flow area of the exit of the port of the intake manifold can be undersized in relation to a maximum flow-rate at which the air and fuel mixture can be drawn into a cylinder of the engine at maximum engine power by reciprocating movement of a piston in the cylinder. The port of the intake manifold can be shaped to direct the pressurized at a fuel injector that injects the fuel into the pressurized air.

### BRIEF DESCRIPTION OF THE DRAWINGS

The foregoing summary, as well as, the following detailed description of preferred embodiments, are better understood when read in conjunction with the appended drawings. The drawings are presented for illustrative purposes only, and the scope of the appended claims is not limited to the specific embodiments shown in the drawings. In the drawings:

FIG. 1 is a transverse cross-sectional view of an internal combustion engine;

FIG. 2 is a perspective view of a supercharger and other components of an air induction system of the engine shown in FIG. 1;

FIG. 3 is a top view of the intake manifold shown in FIG. 2;

FIG. 4 is a bottom-side view of the intake manifold shown in FIGS. 2 and 2;

FIG. 5 is a bottom view of the intake manifold shown in FIGS. 2-4;

FIG. 6 is a side view of the intake manifold shown in FIGS. 2-5;

FIG. 7 is a perspective view of the manifold shown in FIGS. 2-6, mated with a cylinder head of the engine shown in FIG. 1, depicting the cylinder head in transverse cross-section and showing an intake valve of the cylinder head in an open position;

FIG. 8 is a transverse cross-sectional view of the manifold shown in FIGS. 2-7, taken through the line “A-A” of FIG. 6, showing the intake valve of the cylinder head in a closed position;

FIG. 9 is a head-on view of the exit of a port of the manifold shown in FIGS. 2-8;

FIG. 10 is a head-on view of the exit of a port of an alternative embodiment of the manifold shown in FIGS. 2-9;

FIG. 11 is a head-on view of the exit of a port of another alternative embodiment of the manifold shown in FIGS. 2-9;

FIG. 12 is a head-on view of the exit of a port of a prior-art intake manifold;

FIG. 13 is a bottom view of the prior-art intake manifold shown in FIG. 12.

### DETAILED DESCRIPTION

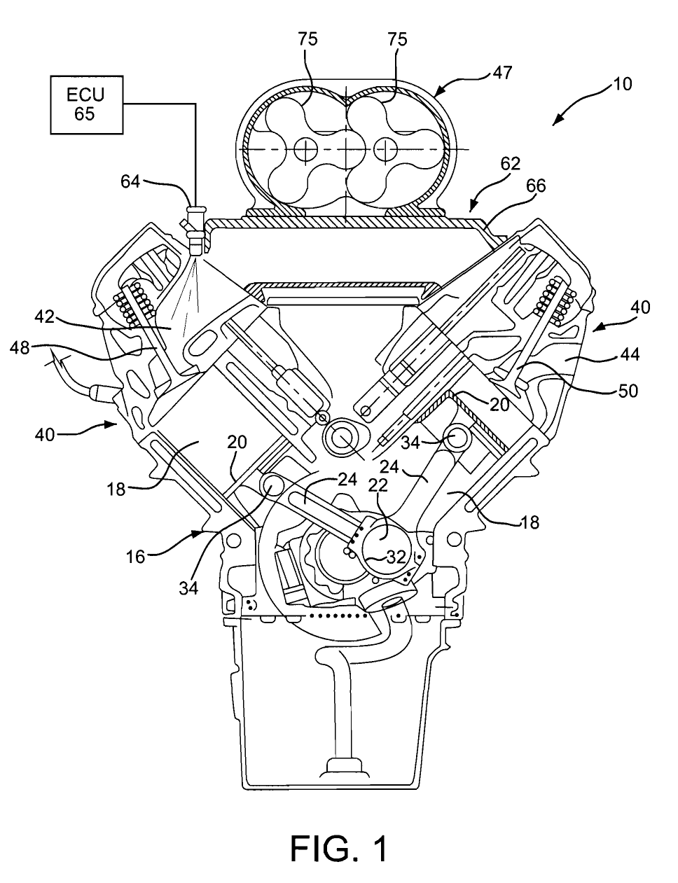

FIG. 1 depicts an internal combustion engine 10 for use in a motor vehicle such as an automobile. The engine 10 is an eight-cylinder V-type engine, commonly referred to as a “V-8.” The engine 10 comprises an engine block 16 having eight cylinder bores or cylinders 18 formed therein, and eight pistons 20 (two cylinders 18 and two pistons 20 are shown in FIG. 1). Each piston 20 is disposed for reciprocating movement in a respective one of the cylinders 18. The engine 10 also includes a crankshaft 22 mounted for rotation on the bottom of the engine block 16, and eight connecting rods 24 (two connecting rods 24 are shown in FIG. 1).

Each connecting rod 24 is connected to the crankshaft 22 using a respective end cap 28. Rotation between the crankshaft 22 and each connecting rod 24 and associated end cap 28 is facilitated by an oil-whetted bearing 32. Each connecting rod 24 is connected to a respective one of the pistons 18 by a piston pin 34.

The engine 10 also comprises two cylinder heads 40 mounted on opposite sides of the engine block 16. Each cylinder head 40 has four intake ports 42 and four exhaust ports 44 formed therein (one intake port 42 and one exhaust port 44 are shown in FIG. 1). Each intake port 42 and exhaust port 44 is associated with a corresponding cylinder 18.

Four intake valves 48 and four exhaust valves 50 are mounted on each cylinder head 40 (one intake valve 48 and one exhaust valve 50 are shown in FIG. 1). One intake valve 48 and exhaust valve 50 are associated with each cylinder 18. The intake valves 48 and exhaust valves 50 open and close in response to actuating forces generated by a camshaft 48, which in turn is driven by and synchronized with the crankshaft 22. The intake valves 48, when open, permit a mixture of fuel and air to enter the associated cylinder 18 by way of the associated intake port 42. The exhaust valves 50, when open, permit combustion products to exit the associated cylinder by way of the associated exhaust port 44.

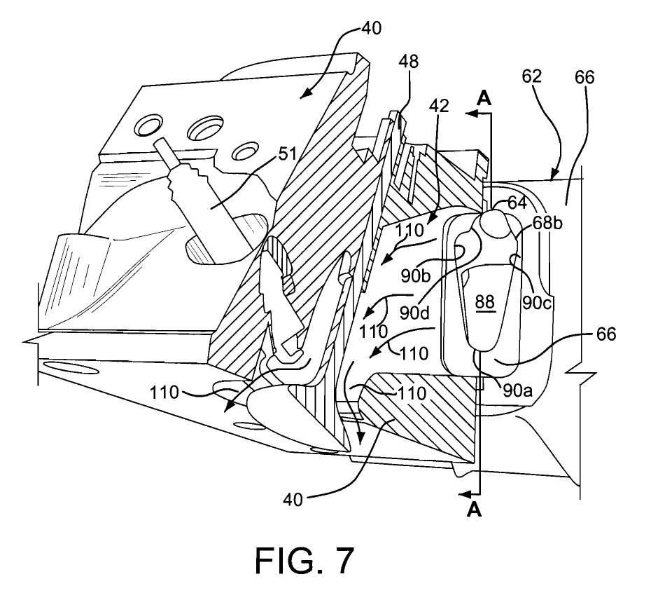

Each piston 20 undergoes a compression stroke in which the piston 20 is driven upward in its associated cylinder 18 by the crankshaft 22. This movement compresses a mixture of fuel and air that has been introduced into the cylinder 18 by way of the associated intake valves 48. The air-fuel mixture is ignited as the piston 20 approaches the end of its compression stroke by a spark provided by an igniter or spark plug 51 (shown in FIG. 7). The resulting combustion of the air-fuel mixture forces the piston 20 and its associated connecting rod 24 downward is its cylinder 18 during the power stroke. The downward movement of the connecting rod 24 imparts rotation and torque to the crankshaft 22. The net torque imparted to the crankshaft 22 by the pistons 20 is transferred to a transmission and drive train of the motor vehicle.

Following the power stroke, the piston 20 is driven upward in its associated cylinder 18 during an exhaust stroke. The exhaust valves 50 associated with the cylinder 18 open during the exhaust stroke in response to the actuating forces generated by the camshaft 48, thereby permitting the combustion products to be evacuated from the cylinder 18 by way of the exhaust port 44 in the associated cylinder head 40.

The piston 18 subsequently undergoes an intake stroke in which the piston 18 is drawn downward the cylinder 18 by the crankshaft 22. The associated intake valves 48 open during the intake stroke to permit a mixture of fuel and air to be drawn into the cylinder 18 by way of the intake port 42 in the associated cylinder head 40. The piston 18 then begins another compression stroke, and the above-described cycle is repeated.

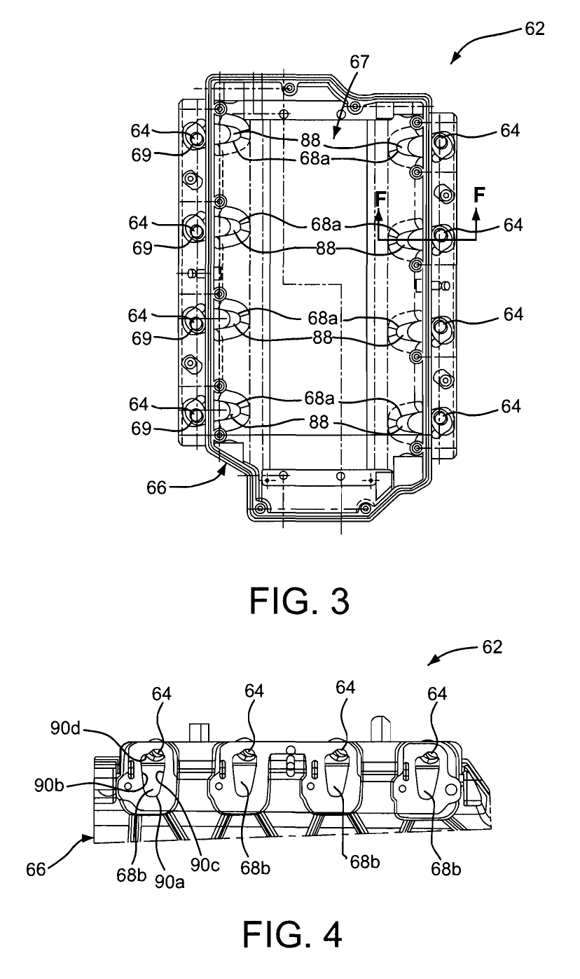

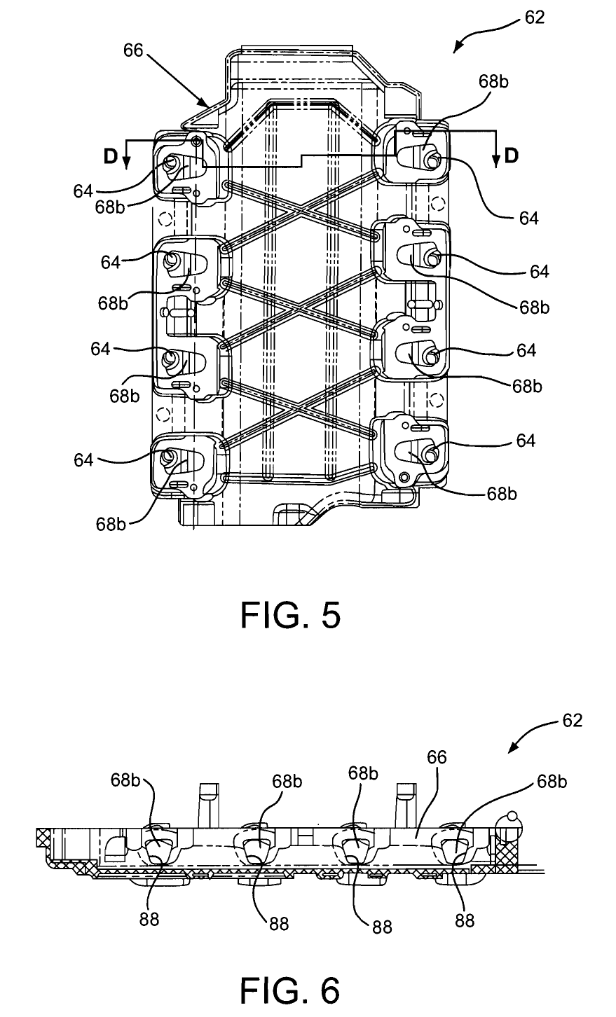

The engine 10 is equipped with a forced-induction, multi-port electronic fuel injection (EFI) system. The EFI system produces the mixture of fuel and air that is directed into the cylinders 18 and combusted. The EFI system includes an intake manifold 62, eight fuel injectors 64, and an electronic control unit (ECU) 65, as shown in FIG. 1. The manifold 62 forms part of an air-induction sub-system of the EFI system. The depiction of the manifold 62 in FIG. 1 is diagrammatic; specific details of the manifold 62 are shown in FIGS. 3-9.

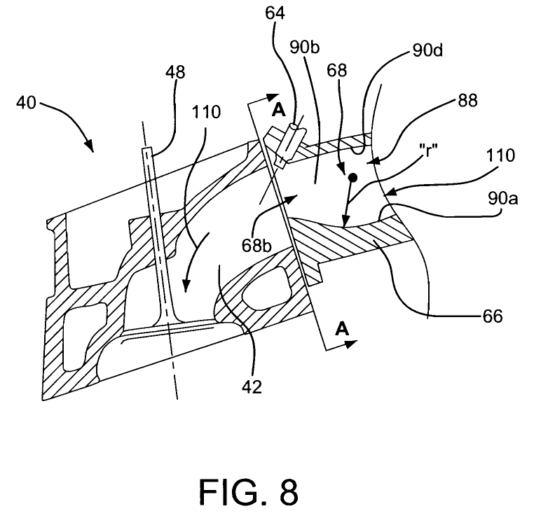

The manifold 62 comprises a body 66. The body 66 defines an open volume, or plenum 67, as shown in FIG. 3. The body 66 also defines eight ports 68 that each adjoin the plenum 67 so that an inlet or entrance 68a the each port 68 is in fluid communication with the plenum 67. The manifold 62 mates with the cylinder heads 40 as shown in FIG. 8, so that an outlet or exit 68b of each port 68 aligns with, and is in fluid communication with a corresponding one of the intake ports 42 on one of the cylinder heads 40.

The fuel injectors 64 are mounted in respective bores 69 formed in the body 66 of the manifold 62, as shown in FIG. 3. Each fuel injector 64 injects fuel into an associated one of the ports 68, proximate the exit 68b thereof. Fuel is delivered under pressure to the fuel injectors 64 via fuel delivery pipes (not shown), or other suitable means. The fuel is supplied to the fuel delivery pipes from a fuel tank of the motor vehicle (not shown) via a fuel pump, a fuel pressure regulator, and a fuel filter (also not shown).

The air-induction subsystem of the EFI system also comprises a compressor in the form of a supercharger 74. The use of the supercharger 74 as the compressor is disclosed for exemplary purposes only. Other types of pneumatic compressors, such as turbochargers, can be used in the alternative.

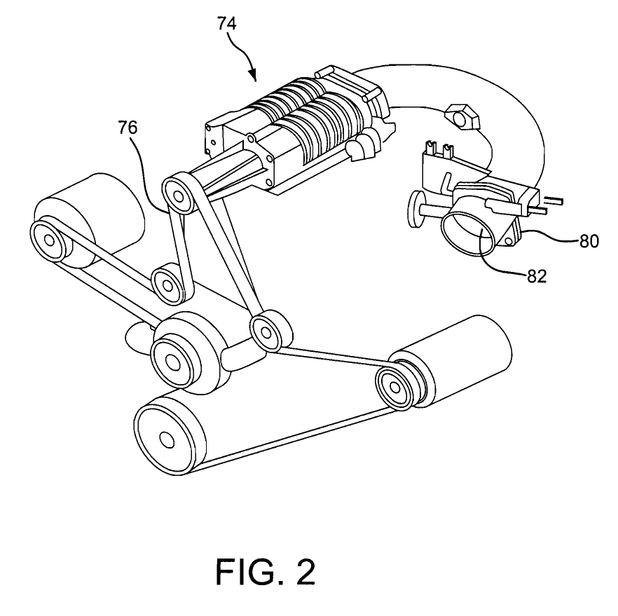

The supercharger 74 is mounted on the manifold 62 as shown in FIG. 1, so that the supercharger 74 is in fluid communication with the plenum 67 of the manifold 62. The supercharger 74 is a positive displacement air pump that increases the pressure and density of the air passing through it. The supercharger 74 can be, for example, a Roots supercharger (or a variant thereof) comprising two rotors 75 with intermeshing lobes mounted inside an outer casing of the supercharger 74. The rotors are driven by a drive gear (not shown) and a belt 76 shown in FIG. 2, which in turn are driven by the crankshaft 22. Alternatively, the supercharger 74 can be a twin screw or centrifugal supercharger.

Ambient air is supplied to the supercharger 74 by way of an inlet plenum 78 and a throttle body 80 shown in FIG. 2, and an air filter (not shown). The throttle body 80 includes a throttle valve 82 that opens when the driver of the motor vehicle presses the vehicle's accelerator pedal. The opening of the throttle valve 82 increases the flow-rate of the air that passes through the throttle body 80 and reaches the supercharger 74.

Each fuel injector 64 is an electric solenoid that responds to electrical inputs from the ECU 65. The ECU 65 comprises a processor that schedules and controls the rate of fuel flow through the injectors 64 based on inputs from a various sensors of the EFI system. These inputs can include, for example, engine airflow and speed (rpm), throttle valve position, exhaust oxygen content, etc. Under part-power, e.g., 90 percent throttle and below, steady-state operating conditions, the EFI schedules the fuel flow to produce a stoichiometric air-fuel ratio of about 14.7:1. During acceleration and high-power operation, the EFI enriches the air-fuel mixture to a ratio of, for example, about 12.5:1.

During operation of the of the engine 10, air is drawn into the supercharger 74 through the air filter, the throttle body 80, and the inlet plenum 78. The flow rate of the air is determined primarily by position of the throttle valve 82. The air is compressed upon passing through the rotors of the supercharger 74. The boost, or compression provided by the supercharger 74 can be, for example, about six psi at maximum engine power.

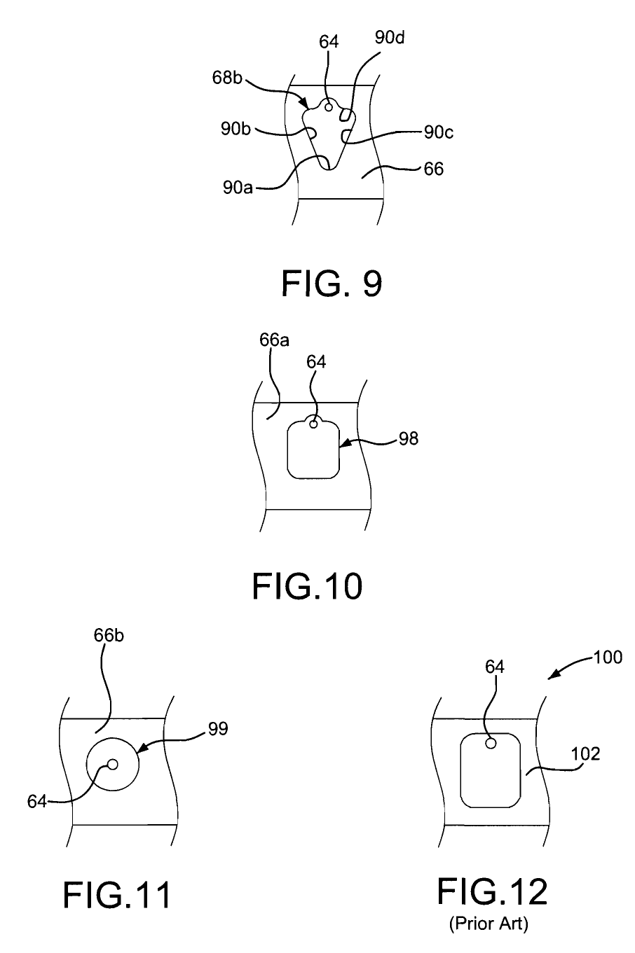

The pressurized air from the supercharger 74 is discharged into the plenum 67 of the manifold 62. The pressurized air subsequently enters the ports 68 of the manifold 62 by way of the port entrances 68a. The gross direction of flow through the ports 68 and the intake ports 44 of the cylinder head 40 is denoted by the arrows 110 in FIGS. 8 and 9. Pressurized fuel is injected into the air flowing through each port 68 by the associated fuel injector 64, in accordance with the fuel schedule determined by the ECU 65. The pressurized fuel atomizes upon being injected into the airsteam. The resulting air-fuel mixture flows through the associated intake valve 48 and intake port 42 in the cylinder head 40, and into the associated cylinder 18.

The manifold 62 is configured to enhance atomization of the fuel being injected into the ports 68, and to reduce the dwell time of the air-fuel mixture in the intake ports 42 of the cylinder heads 40, particularly at idle, cruise, and other part-power operating conditions. More specifically, each port 68 is sized and shaped to increase the velocity of the airstream passing therethrough so that the fuel is injected at the approximate location where the airstream reaches its maximum velocity within the port 68.

An increase in the velocity of the airstream passing through the ports 68 for a given cylinder volume and piston stroke of the engine 10 is achieved by reducing the flow area of each port 68 along the length thereof, so the flow area reaches its minimum at the port exit 68b, proximate the associated fuel injector 64. A port on a conventional manifold typically has a substantially constant flow area along its length, so that the flow area at the port exit is approximately equal to the flow area of the inlet ports of the cylinder head with which the manifold is used. The exit 68b of each of the ports 68, by contrast, has a flow area that is substantially smaller than that of the inlet ports 42 of the cylinder heads 40, as shown in FIG. 8. The reduced flow area of the exit 68b of the port 68 is achieved by shaping the wall surface 88 that defines the port 68 as shown in FIG. 8, to produce a reduction in the flow area of each port 68 along at least a portion of its length. In essence, the decreasing flow area of the each port 68 causes the port 68 to act as a venturi that accelerates the airstream therein to a maximum velocity proximate the corresponding fuel injector 64.

The ratio of the flow area at the exit 68b of each port 68 to the flow area of the inlet ports 42 is about 35 percent. The optimal value for this ratio is application-dependent, and can vary with factors such as the maximum airflow through the port 68, the amount of boost from the supercharger 74, the length of the port 68, the maximum engine speed, etc. The ratio can be about 20 percent to about 60 percent in alternative embodiments. Moreover, the ratio can be chosen to optimize engine performance at a particular operating condition such as a specific engine speed (rpm) or range of speeds.

Moreover, each port 68 is shaped to focus the airstream toward the corresponding fuel injector 64. In particular, FIGS. 4 and 7-9 depict the shape of the port 68 proximate the fuel injector 64. Each port 68 is defined by the wall surface 88 of the body 66 of the manifold 62, as noted above. The wall surface 88 proximate the fuel injector 64 includes a first portion 90a having a relatively low, constant radius of curvature as viewed from the perspective of FIGS. 4, 7, and 9. The wall surface 88 also includes a second portion 90b and a third portion 90c that adjoin opposite ends of the first portion 90a. The second and third portions 90b, 90c are substantially straight and elongated.

The wall surface 88 further includes a fourth portion 90d that adjoins the second and third portions 90b, 90c. The fuel injector 64 is positioned proximate the fourth portion 90d, as shown in FIGS. 4 and 8. It is believed that the approximate V-shape of the port exit 68b helps to concentrate or focus the local airflow toward the top of the “V” (from the perspective of FIGS. 4, 8, and 9), where the discharge point of the fuel injector 64 is located.

The optimal shape for the ports 68 is application-dependent, and can vary with factors such as the location of the fuel injectors 64 within the ports 68, the size and type of the fuel injectors 64, the shape of the inlet ports 42 of the cylinder head 40, the maximum airflow through the port 68, etc. For example, FIG. 10 depicts an alternative embodiment of the manifold 62 comprising a body 66a having ports 98 with rectangular exits. FIG. 11 depicts another alternative embodiment of the manifold 62 comprising a body 66b having ports 99 with exits. Moreover, in the embodiment of FIG. 11, the fuel injectors 64 have been moved to a location within the port 99 at which the maximum airstream velocity is believed to occur for that particular port shape.

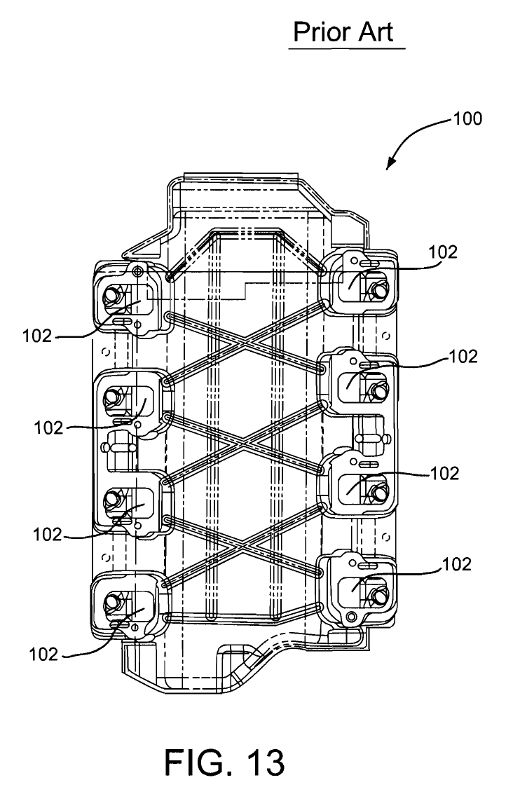

The shape of the ports 68 is believed to direct more of the airstream in the port 68 at and over the fuel injectors 64, and at a higher velocity, in comparison to a conventional General Motors-type port having a substantially rectangular profile along its entire length. FIGS. 12 and 13 depict a standard General Motors intake manifold 100 with rectangular ports 102, for use with a 6.0-6.2 liter V-8 engine.

It is believed that directing a relatively high percentage of the airflow in the ports 68 at and around the associated fuel injectors 64, and increasing the overall velocity of the airstream increase the shear forces acting on the jets of fuel discharged by the fuel injectors 64. The increased shear forces, in turn, are believed to decrease the size, or mean diameter, of the fuel droplets in the resulting air-fuel mixture. The decreased static pressure of the airflow caused by the acceleration thereof is also believed to enhance atomization of the fuel into relatively small droplets.

Reducing the droplet size can increase the efficiency at which the mixture is subsequently combusted in the cylinders 18, potentially leading to improvements in engine power, emission levels, and fuel consumption. Reducing the droplet diameter can also improve the uniformity with which the droplets are distributed in the air-fuel stream, which can lead to further increases in combustion efficiency.

The relatively high velocity of the airstream is also believed to reduce the dwell time of the air-fuel mixture in the intake ports 42 of the cylinder heads 40. The reduction in dwell time can reduce the overall amount of fuel that settles out of the mixture and collects on the walls of the intake ports 42, potentially leading to further improvements in engine power, emission levels, and fuel consumption.

The above-noted effects are believed to be particularly beneficial at idle, cruise, and other part-power conditions, where the velocity of the airstream within the manifold ports 68 is relatively low. Reducing the flow area of the manifold ports 68, however, reduces the maximum airflow through the manifold 62. Adequate maximum power can be maintained despite the reduction in maximum airflow through the use of the boost from the supercharger 74.

Moreover, it is believed that the improvements in the quality of the air-fuel mixture achieved through the use of the manifold 62 can reduce the tendency for the mixture to detonate in response to the boost from the supercharger 74 during low-power operation. Thus, the need to enrich the air-fuel mixture at relatively low power settings can be eliminated, along with the corresponding penalties in engine fuel consumption and emissions.

It is also believed that the reduction in maximum airflow resulting from the decreased flow area of the ports 68 can be minimized by reducing or eliminating any abrupt turning of the airstream as it travels through the ports 68. This can be accomplished by configuring the wall surface 88 with relatively large, i.e., 0.5-inch or greater, radii in its lengthwise, or flow direction. FIG. 9 shows one of the relatively large radii “r” of the wall surface 88 in the flow direction. The optimal value, or range of values for the radii is application-dependent, and can vary with factors such as the flow area of the port 68, the maximum velocity of the airstream within the port 68, the amount of boost from the supercharger 74, etc.

Applicant installed a manifold substantially similar to the manifold 62 on a 6.0-liter, eight-cylinder General Motors engine equipped with a modified Roots supercharger producing about six pounds of boost at maximum engine power. Engine performance was evaluated under laboratory conditions. Engine emissions were determined to be well within, i.e., better than, the California state motor vehicle pollution control standards throughout the drive profile used to evaluate emissions under these standards. Moreover, improvements of ten percent or more in fuel consumption were realized. It is believed that even further improvements can be achieved with further optimization of various engine operating parameters.

It is not necessary to modify the entrances of the intake ports 42 of the cylinder heads 40 to match the exits of the ports 68 of the manifold 62. In particular, the intake ports 42 can retain their rectangular shape and relatively large flow area. It is believed that the acceleration of the air-fuel mixture effectuated by the reduced flow area of the manifold ports 68 causes the air-fuel mixture to pass through the intake port 42 more quickly than would otherwise be possible, regardless of the rectangular shape and relatively large size of the intake ports 40. Thus, the potential benefits of the manifold 62 can be achieved without a need to replace or modify the stock cylinder heads.

Moreover, the relatively small size of the exit of the manifold port 68 in relation to the entrance of the inlet port 42 is believed to cause the manifold 62 to act as an anti-reversion feature. In particular, pressure waves in the air-fuel mixture in the cylinders 18 and the inlet ports 42 of the cylinder heads 40 can be generated by factors such as the motion of the pistons 20 during their intake stroke, and the closing of the intake valves 48 at the completion of the intake stroke. These pressure waves travel upstream, and can cause the atomized fuel droplets in the air-fuel mixture to settle out of the mixture and collect on the walls of the intake ports 42 and the cylinders 18. A portion of the body 66 of the manifold 62 overlaps or extends over the entrance to each inlet port 42 as shown in FIG. 8, due to the differences between the flow areas of each intake manifold port 68 and its associated inlet port 40 at the interface thereof. The overlapping portion of the manifold 62 is believed to reflect the pressure waves back toward, and into the cylinders 18, thereby reducing the tendency of the fuel droplets to settle out of the air-fuel mixture.

The foregoing description is provided for the purpose of explanation and is not to be construed as limiting the invention. Although the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, can make numerous modifications to the invention as described herein, and changes may be made without departing from the scope and spirit of the invention as defined by the appended claims.

For example, the inventive concepts disclosed herein are described in connection with a four-stroke V-8 engine for exemplary purposes only. Alternative embodiments of the air-fuel delivery system 60 can be configured for use with other types of engines, including engines having more, or less than eight cylinders arranged in a manner other than a standard “V” configuration; two-stroke engines; engines having more than one intake valve and one exhaust valve per cylinder; and naturally-aspirated engines. Moreover, the inventive concepts can be applied to engines used in applications other than motor vehicles.

What is claimed is:

1. A system for supplying a mixture of fuel and air to a cylinder of an internal combustion engine, comprising:
a cylinder head having an inlet port for directing the mixture of air and fuel to the cylinder;
a fuel injector; and
a manifold having a port in fluid communication with the inlet port of the cylinder head, wherein an inlet of the manifold port receives an airstream, the fuel injector is mounted on the manifold and injects fuel into the airstream to form the mixture of air and fuel, and an exit of the manifold port has a flow area between about 20 percent and about 60 percent of a flow area of an entrance of the inlet port.

2. The system of claim 1, further comprising a compressor in fluid communication with the inlet of the manifold port, wherein the compressor discharges the airstream at a pressure greater than ambient pressure.

3. The system of claim 1, wherein the flow area of the port decreases along at least a portion of the length of the port.

4. The system of claim 3, wherein the flow area of the port reaches a minimum at a location proximate the location at which the fuel injector injects the fuel into the airstream.

5. The system of claim 1, wherein the manifold comprises means for focusing the airstream toward a potion of the fuel injector located within the manifold port.

6. The system of claim 5, wherein the means for focusing the airstream toward a potion of the fuel injector located within the manifold port comprises a wall surface of a body of the manifold.

7. The system of claim 1, wherein the exit of the manifold port is approximately V-shaped.

8. The system of claim 7, wherein:
the manifold comprises a body having a wall surface that defines the manifold port;
the wall surface proximate the exit of the manifold port has a curvilinear first portion, substantially straight second and third portions that adjoin opposite ends of the curvilinear portion, and a fourth portion that adjoins the second and third portions; and
the fuel injector is located proximate the fourth portion and distal the first portion.

9. The system of claim 1, wherein the flow area of the exit of the manifold port is about 35 percent of the flow area of the entrance of the inlet port.

10. An air-induction system for an internal combustion engine comprising a cylinder and a piston disposed for reciprocating movement within the cylinder, the air-induction system comprising a compressor and a manifold in fluid communication with the compressor, wherein:
the manifold has a port that receives pressurized air from the compressor and a bore that receives a fuel injector for discharging fuel into the pressurized air received by the manifold port from the compressor to form a mixture of air and fuel; and
a minimum flow area of the port is undersized in relation to a maximum flow-rate at which the air and fuel mixture can be drawn into the cylinder at maximum engine power by the reciprocating movement of the piston.

11. The air-induction system of claim 10, wherein the manifold further comprises a wall surface that defines the port, and the wall surface is configured to direct the pressurized air from the compressor toward a portion of the fuel injector located within the port.

12. The system of claim 10, further comprising a cylinder head having an inlet port in fluid communication with the manifold port and the cylinder, wherein an exit of the manifold port has a flow area between about 20 percent and about 60 percent of a flow area of an entrance of the inlet port.

13. The system of claim 12, wherein the flow area of the exit of the manifold port is about 35 percent of the flow area of the entrance of the inlet port.

14. The system of claim 11, wherein an exit of the port is approximately V-shaped.

15. The system of claim 14, wherein:
the wall surface proximate the exit of the port has a curvilinear first portion, a substantially straight second and third portion that adjoin opposite ends of the curvilinear portion, and a fourth portion that adjoins the second and third portions; and
the bore for the fuel injector is located proximate the fourth portion and distal the first portion.

16. The system of claim 10, wherein the minimum flow area occurs proximate an exit of the port and a maximum flow area of the port occurs proximate an entrance to the port.

17. An electronic fuel injection system for an internal combustion engine, comprising:
a fuel injector that discharges fuel;
an electronic control unit communicatively coupled to the fuel injector, wherein the fuel injector is responsive to an input from the electronic control unit that regulates an amount of the fuel discharged by the fuel injector; and
a manifold, wherein the manifold comprises a body having a wall surface defining a port that receives an airstream, the fuel injector is mounted on the manifold so that a portion of the fuel injector is located in the port, and the wall surface is shaped to focus the airstream at the portion of the fuel injector located in the port.

18. The system of claim 17, further comprising a compressor in fluid communication with the manifold for pressurizing the airstream before the airstream reaches the port of the manifold.

19. The system of claim 17, wherein a flow area of the port decreases along a length of the port so that the flow area is minimum and a velocity of the airstream is maximum proximate the portion of the fuel injector located in the port.

20. The system of claim 17, wherein a minimum flow area of the port is undersized in relation to a maximum flow-rate at which the air and fuel mixture can be drawn into a cylinder of the engine at maximum engine power by reciprocating movement of a piston disposed in the cylinder.
